(19) United States
(12) Patent Application Publication
(10) Pub. No.: US 2005/0142338 A1
(43) Pub. Date: Jun. 30, 2005

(54) Method and apparatus for producing decorating means suitable for decorating objects, and relative decorating means

(76) Inventor: Giancarlo Fenzi, Illasi (IT)

Correspondence Address: NIXON & VANDERHYE, PC, 1100 N GLEBE ROAD, 8TH FLOOR, ARLINGTON, VA, 22201-4714, US

(21) Appl. No.: 10/513,414

(22) PCT Filed: May 16, 2003
(86) PCT No.: PCT/EP03/05169

(30) Foreign Application Priority Data
May 16, 2002 (IT) MO2002A00126

(51) Int. Cl. B05D 3/12; B44C 1/165

(52) U.S. Cl. 428/195.1; 427/355; 156/230

(57) ABSTRACT

“A method comprises feeding a first layer arrangement towards a decorating zone, decorating said first layer arrangement, and coupling said first layer arrangement with a second layer arrangement so as to obtain flexible decorating interlayer, said decorating comprising transferring onto said first layer arrangement a decorative pattern from a support element that initially supports said decorative pattern. An apparatus comprises first a feed device arranged for feeding a first layer arrangement towards a decorating zone, and coupling device arranged for coupling said first layer arrangement with a second layer arrangement so as to obtain flexible decorating interlayer, said decorating zone being provided with a transfer device that is so configured as to transfer a decorative pattern onto said first layer from a support element on which said decorative pattern is initially supported. Flexible decorating interlayer comprises base layer arrangement bearing a decorative pattern, said base layer arrangement being associated with a protection arrangement that serves to prevent said base layer arrangement from sticking to adjacent materials.”

The invention concerns a method and an apparatus for producing decorating means suitable for decorating objects, particularly made of transparent material, such as glass or plastic material, and the relative decorating means;

U.S. Pat. No. 3,868,286 discloses a process for producing a polyvinyl butyral (PVB) composite interlayer for laminated safety glass. According to said process, a first transparent PVB sheet is decorated on one side with a set design in a printing station, and is then laminated with a second transparent PVB sheet. A composite layer is thereby obtained that is suitable for being placed between two glass plates to obtain decorated safety glass, e.g. a windscreen for vehicles having a top coloured band suitable for preventing the sun's rays from dazzling the driver.

The decorated composite layer can be placed between the glass plates immediately after being produced, or can be wound onto a reel and stored until it is sent to a glassworks.

One defect of the process disclosed in U.S. Pat. No. 3,868,286 is due to the difficulty of decorating PVB sheets because of the rather soft, lined and sticky nature of said material. Rotary printing techniques such as flexographic printing and gravure printing provide rather unsatisfactory results when they are used for printing on PVB sheets because the PVB tends to stick to the print rollers and the precision of the decoration is adversely affected.

This defect, which may not be particularly noticeable if monochrome bands are printed for the windscreen of motor vehicles, becomes dramatically important if more complicated patterns have to be obtained, said patterns being made up of a large number of colours and having relatively complex contours. A further defect of the process disclosed in U.S. Pat. No. 3,868,286 is due to the fact that PVB is a material with relatively high adhesive power. For this reason, when an interlayer of the type disclosed in U.S. Pat. No. 3,868,286 is wound onto reels wherein a sheet of PVB is in direct contact with an underneath sheet of the same material, the two sheets in contact often stick together, thereby making it difficult to unwind the decorated composite layer from the reel. During unwinding the composite layer may suffer lacerations or tears that impair the quality of the final decorated glass.

Yet another further defect of the prior art described above is that the decorated composite layer can easily be damaged during handling, inasmuch as it may be contaminated by powder or other impurities or be scratched by objects with which it may come into contact. The damaged composite layer can obviously not be used to decorate the glass unless a low-quality final decoration is accepted.

U.S. Pat. No. 4,173,672 discloses a process for producing decorated safety glass, wherein a coloured impression is transferred from a temporary cellulosic support sheet to a PVB adhesive plastic film spread on a first lamina of glass. This transferring is achieved by means of heat and pressure. The temporary cellulosic support is removed when the coloured impression has been transferred from the cellulosic layer to the PVB and a second lamina of glass is placed over the PVB decorated film in direct contact with it. The two glass laminas and the interposed decorated film are then subject to heat and pressure until the colouring material gets impregnated into the PVB semi-fluid film so as to make this film transparent.

According to U.S. Pat. No. 4,173,672, it is necessary to transfer the coloured impression from the temporary cellulosic support to the PVB film when the latter is already placed onto the first lamina glass, because it is very difficult to work on the PVB film due to its adhesive consistency and to its great plasticity.

However, the process disclosed in U.S. Pat. No. 4,173,672 requires a long time to be carried out, since two heating and pressing steps are required in order firstly to associate the coloured impression to the PVB and then to put the two glass laminas together.

Moreover, the safety glass manufacturer has to keep in his premises all the necessary materials for transferring the coloured impression from the temporary cellulosic support to the PVB film, which requires large warehouses and can cause troubles when the exhausted cellulosic support has to be disposed of.

U.S. Pat. No. 5,019,440 discloses a process for producing a decorative glass or plastic plate, comprising spraying onto the glass plate a mixture containing a curing agent, curing said mixture so as to obtain a cured layer, and transferring onto the cured layer a printing image formed on a transfer sheet. A coating layer is then applied onto the transferred image.

One aim of the invention is to improve the methods and apparatuses for producing decorating means suitable for decorating objects, particularly in transparent material, such as glass, and the relative decorating means.

A further aim of the invention is to enable decorated objects to be obtained that have great print precision.

A further aim of the invention is to supply decorating means that cannot be easily damaged, even if it is used in environments that contain dust or impurities or if is handled ungently.

Yet another aim of the invention is to prevent the decorating means from sticking together when it is wound onto reels or is placed in contact with one another.

Another aim of the invention is to simplify the systems for decorating glass and other transparent materials.

According to a first aspect of the invention, a method is provided, comprising feeding first layer means towards a decorating zone, decorating said first layer means, and coupling said first layer means with second layer means so as to obtain flexible decorating means, said decorating comprising transferring onto said first layer means a decorative pattern from support means that initially supports said decorative pattern.

According to a second aspect of the invention, an apparatus is provided, comprising first feed means arranged for feeding first layer means towards a decorating zone, and coupling means arranged for coupling said first layer means with second layer means so as to obtain flexible decorating means, said decorating zone being provided with transfer means that is so configured as to transfer a decorative pattern onto said first layer means from support means on which said decorative pattern is initially supported.

Owing to these two aspects of the invention, it is possible to obtain decorating means provided with decorations printed with a high degree of print resolution. Transfer print technology enables even complicated patterns to be printed with significant precision on the decorating means, which patterns may comprise a large number of different colours. This advantage is particularly apparent when the material of the first layer means has a relatively soft and adhesive consistency, and cannot be decorated with good results using direct print techniques such as rotary printing.

The decorating means thereby obtained is furthermore provided with excellent long-term stability properties even when it is exposed to atmospheric agents and direct sunlight. In fact, the transfer printing technology enables inks containing light-resistant pigments to be used, which allows the brightness and intensity of colour to be maintained even several years after installation of the decorated object.

The flexible decorating means produced with the process or the apparatus disclosed above may be used to decorate transparent materials, such as glass or plastic plates. The transparent materials manufacturer can purchase the flexible decorating means from a producer thereof and simply associate said flexible decorating means with the glass or plastic plates to be decorated. Thus, the transparent materials manufacturer does not need to carry out any decorating step on sheets that are intended to be interposed between plastic or glass plates. According to a third aspect of the invention, flexible decorating means is provided, comprising base layer means bearing a decorative pattern, characterised in that, said base layer means is associated with protection means that serves to prevent said base layer means from sticking to adjacent materials.

The protection means allows the flexible decorating means to be wound on a reel, since the protection means prevents portions of the base layer means from sticking to adjacent portions of said base layer means already wound on the reel. It is therefore, possible to store the flexible decorating means and to use it to decorate glass or other transparent material after a certain period of time. The processes for producing transparent decorated material are therefore greatly simplified, since the manufacturer merely needs to couple the ready-to-use flexible decorating means to glass or plastic plates.

Furthermore, the protection means also prevents the decorating means from being damaged in the event of contact with contaminating substances, or in the case of its being subjected to abrasive action.

In order that the invention may be clearly and completely disclosed, reference will now be made, by way of examples that do not limit the scope of the invention to the accompanying. drawings, wherein:

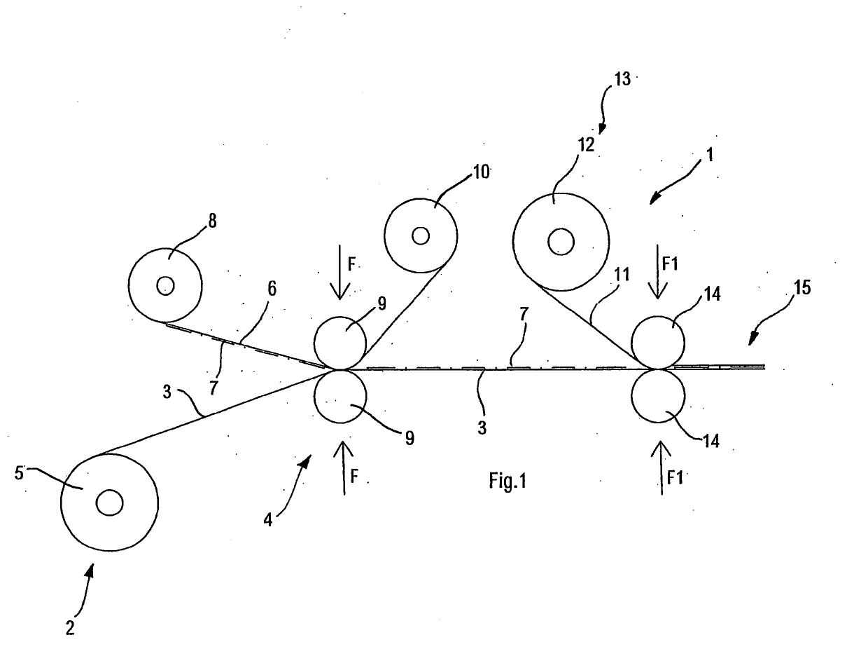

FIG. 1 is a diagrammatic frontal view of an apparatus for producing decorating means suitable for decorating objects;

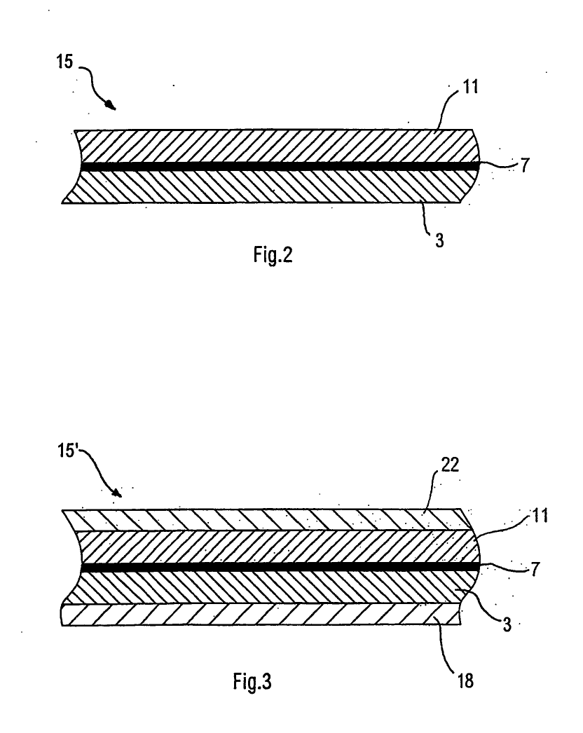

FIG. 2 is an enlarged and interrupted diagrammatic cross-section of decorating means suitable for decorating objects;

FIG. 3 is an enlarged and interrupted cross-section of an alternative embodiment of the decorating means of FIG. 2;

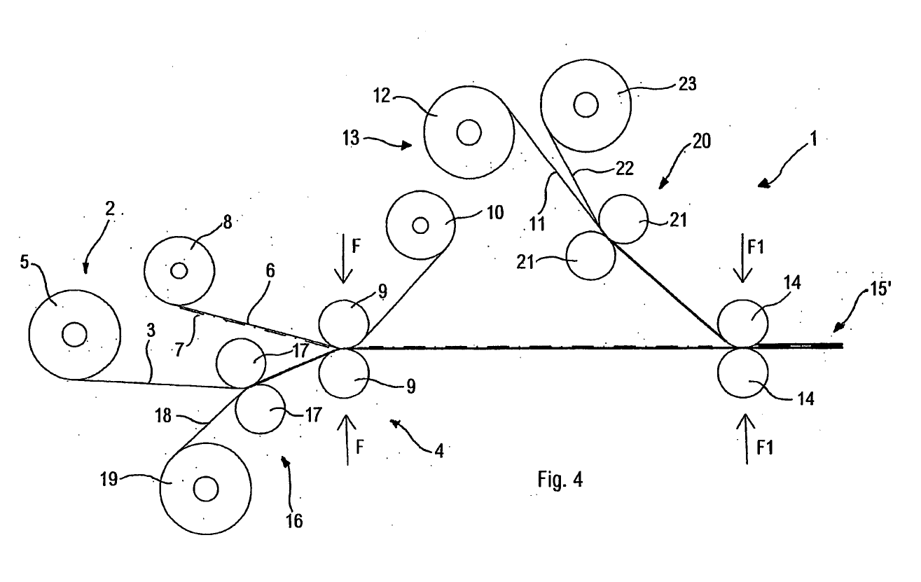

FIG. 4 is a diagrammatic frontal view of an alternative embodiment of the apparatus of FIG. 1;

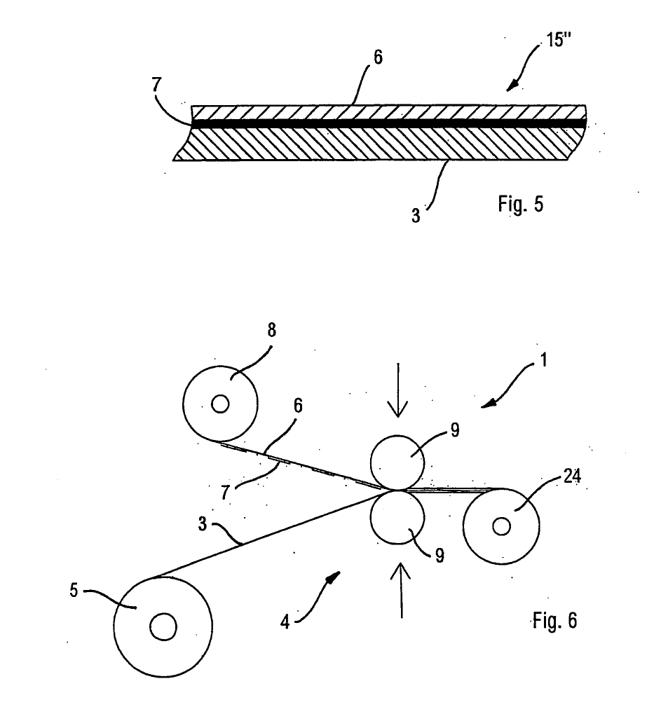

FIG. 5 is an enlarged and interrupted diagrammatic cross-section of a further alternative embodiment of the decorating means of FIG. 2;

FIG. 6 is a diagrammatic frontal view of an apparatus for producing the decorating means of FIG. 5.

FIG. 1 shows an apparatus 1 for producing decorating means suitable for decorating objects, said objects being preferably made of a transparent material such as glass or plastic material. The apparatus 1 comprises first feed means 2 suitable for feeding a first base layer 3, for example in the form of a sheet, towards a decorating zone 4. The first feed means 2 is provided with a device that is not shown for supporting a first reel 5, on which the first base layer 3 is initially wound, and for unwinding said first base layer 3 from the first reel 5.

In the decorating zone 4, the first base layer 3 contacts a support 6, for example in the form of a sheet, bearing a decorative pattern 7 on one side and initially wound on a further reel 8. The support 6 may be a film made of polypropylene, or of any other plastic material from which the decorative pattern 1 is easily detached by temperature and/or pressure. To facilitate detachment, appropriate paints can also be applied to the support 6 to facilitate its release.

The decorative pattern 7, was previously printed onto the support 6 by means of any known printing technique, for example gravure printing, flexographic printing, offset printing or any other type of printing. To create the decorative pattern 7 an arbitrary number of colours was used and inks were employed containing light-resistant pigments that can maintain their colour intensity even after prolonged exposure to atmospheric agents and to the sun in particular. It is in particular possible to use inorganic pigments to obtain the colours white and black, or macromolecules of organic origin to obtain the remaining colours.

The decorative pattern 7 is transferred to the first base layer 3 in the decorating zone 4 by means of transfer means comprising a pair of pressure rollers 9, the distance of which from each other may be adjusted as indicated by the arrows F by known adjusting means that is not shown here. One or both the pressure rollers 9 may be advantageously heated, so that the decorative pattern 7 can be easily transferred from the support 6 to the first base layer 3. Experimental tests have shown that particularly good results can be obtained by cladding one or both the pressure rollers 9 with a layer of hard or silicon rubber.

After the decorative pattern 7 has been transferred onto the first base layer 3 through the combined action of heat and pressure, the exhausted support 6 is wound onto an exhausted reel 10, which may be disposed of in compliance with current regulations or be reused as packing material. The first base layer 3 with the decorative pattern 7 that was previously transferred onto it is then coupled with a second base layer 11, for example in the form of a sheet, which is applied onto the decorative pattern 7 from the side opposite the first base layer 3.

The second base layer 11 is fed by second feed means 13, comprising a further device that is not shown for supporting a second reel 12, onto which the second base layer 11 is initially wound. The second feed means 13 further comprises means that is not shown for unwinding the second base layer 11 from the second reel 12. The second base layer 11 is coupled with the first base layer 3, provided with the decorative pattern 7, by means of coupling means comprising further pressure means, for example a pair of further rollers 14. The mutual distance between the further rollers 14 may be adjusted as indicated by the arrows F1 by known adjusting means that is not shown here.

One or both the further rollers 14 may be heated in such a way that the second base layer 11 more easily joins the first base layer 3. Like the pressure rollers 9, the further rollers 14 may also be clad with hard or silicon rubber.

At the outlet of the further rollers 14, flexible decorating means is thus obtained that comprises a composite layer 15 that has the structure disclosed in FIG. 2. The composite layer 15 is provided with a decorative pattern 7 placed between a first base layer 3 and a second base layer 11.

The composite layer 15 may be used to decorate, for example, glass plates. In particular, the composite layer 15 may be placed between two glass plates and used to mutually connect said glass plates according to the known techniques for constructing layered glass.

Both the first base layer 3 and the second base layer 11 can be made of polyvinyl butyral, a material that has good adhesive properties and, when placed between the glass plates at suitable temperature and pressure conditions, softens and acts as a glue that ensures good fixing between said plates. Unlike direct printing techniques such as flexographic printing or gravure printing, transfer printing enables high-quality decorations to be achieved even on polyvinyl butyral because the support 6, which is made from a material that is different from polyvinyl butyral, may easily be printed with high resolution and images that have well defined contours and are subsequently transferred to the polyvinyl butyral with no loss of quality.

In an alternative embodiment, disclosed in FIG. 4, the apparatus 1 is provided with first associating means 16, comprising a pair of cylinders 17, suitable for associating the first base layer 3 unwound from the first reel 5 with a first protection layer 18 initially wound onto a start reel 19. The cylinders 17 can apply pressure and/or a temperature that will make the first protection layer 18 stick to the first base layer 3. The latter is then decorated on the side that is not in contact with the first protection layer 18 in the manner previously disclosed.

The apparatus 1 further comprises second associating means 20 provided, with two further cylinders 21, that are similar to the cylinders 17 and are suitable for coupling the second base layer 11 with a second protection layer 22 unwound from a further start reel 23.

The assembly comprising the second base layer 11 and the second protection layer 22 is subsequently coupled, by means of the further rollers 14, to the first base layer 3 that has been previously decorated and associated with the first protection layer 18.

The structure of the resulting composite layer 15′ is disclosed in detail in FIG. 3.

The material of the first protection layer 18 and of the second protection layer 22 may be polypropylene or polyethylene. Any protective film may be used, but it is preferable to use a material with non-adherent properties, particularly in cases wherein the composite layer is not immediately inserted between the glass plates to be decorated, but is stored, for example in the form of a reel, and is subsequently sent to a manufacturer of objects in glass or transparent material.

If the layers of polyvinyl butyral are wound onto a reel without protection layers, said layers tend to stick together and thus make it difficult to unwind the composite layer from the reel when the glass has to be decorated and make breaks or lacerations in said layers more likely.

The adhesive force between the first protection layer 18 and the first base layer 3, and between the second protection layer 22 and the second base layer 11 respectively should be sufficiently low to enable the protection layers to be easily removed from the base layers when the composite layer is used before it is inserted between the glass plates.

It is also possible to simply superimpose the protection to layers on the composite layers without creating any reciprocal link.

In an alternative embodiment, similar to the one disclosed in FIG. 1, the materials wound onto the first reel 5 and onto the second reel 12 may comprise base layers already coupled with the respective protection layers. Thus, an apparatus like the one in FIG. 1 enables a composite layer to be obtained that has the structure disclosed in FIG. 3.

Instead of the polyvinyl butyral other suitable materials can be used, in particular polyurethane (PU), or ethylene vinyl acetate (EVA).

FIG. 6 shows a further embodiment of the apparatus 1, which allows a composite layer 15 having the structure shown in

FIG. 5 to be obtained.

According to the apparatus of FIG. 6, the first base layer 3 is unwound from the first reel 5 and conveyed towards the decorating zone 4. Here the first base layer 3 meets the support 6 unwound from the further reel 8 and bearing the decorative pattern 7. The pressure rollers 9 press the support 6 against the first base layer 3 and heat is applied so that the decorative pattern 7 is transferred from the support 6 to the first base layer 3, for example by sublimation.

Instead of rewinding the exhaust support onto the exhaust reel as provided in the embodiment of FIG. 1, the first base layer 3 bearing the decorative pattern 7 and the support 6 are conveyed towards an exit region of the apparatus 1 and are wound onto a final reel 24.

The pressure rollers 9 act therefore both as a transfer means which allows the decorative pattern 7 to be transferred onto the first base layer 3 from the support 6 and as a coupling means which couples the first base layer 3 to the support 6. The support 6 coupled to the first base layer 3 works as a protection layer which prevents portions of the first base layer 3 from sticking to underlying portions of the same first base layer 3 when wound on the final reel 24. It is therefore possible to unwind the intermediate layer 15 from the final reel 24 without damaging the first base layer 3 and the decorative pattern 7 applied thereto.

The support 6 furthermore protects the decorative pattern from dust and scratches thus allowing a high quality decorated glass to be obtained.

During the decorated glass production process, the intermediate layer 15 is unwound from the final reel 24, the support 6 is, separated from the first base layer 3 and the latter is placed onto a first glass plate. A second glass plate is then positioned onto the decorated first base layer, and the two glass plates are subject to heat and pressure to obtain a single laminated glass. If the manufacturer so desires, he may also couple a second PVB layer to the decorated first base layer placed onto the first glass plate. It is observed that the embodiment disclosed in FIG. 6 is particularly simple and allows savings to be achieved in the costs of the protection material, since the exhaust support is also used as a protection means.

1-39. (canceled)

40. Method for manufacturing a flexible interlayer for laminated glass, comprising feeding a first layer arrangement towards a decorating zone, decorating said first layer arrangement with a decorative pattern initially arranged in contact with a support element that supports said decorative pattern, and coupling said first layer arrangement with a second layer arrangement so as to obtain said flexible interlayer, decorating comprising releasing said decorative pattern from said support element and transferring said decorative pattern onto said first layer arrangement, wherein said method further comprises winding said flexible interlayer onto a reel, after said coupling.

41. Method according to claim 40, wherein said transferring comprises applying pressure to said support element when said support element is in contact with said first layer arrangement.

42. Method according to claim 40 wherein said transferring comprises heating said support element.

43. Method according to claim 40, wherein said transferring comprises further heating said first layer element, near said decorating zone.

44. Method according to claim 40, wherein said decorative pattern is printed on said support element with inks containing light-resistant pigments.

45. Method according to claim 40, wherein said support element is made of polypropylene (PP).

46. Method according to claim 40, wherein said feeding comprises associating a first base layer of said first layer arrangement with a first protection layer, suitable for protecting said first base layer.

47. Method according to claim 40, and further comprising further associating a second base layer of said second layer arrangement with a second protection layer, suitable for protecting said second base layer.

48. Method according to claim 40, wherein, after said transferring, said support element remains associated with said first layer arrangement, so that said support element also acts as second layer arrangement.

49. Method according to claim 48, wherein said coupling and said transferring occur substantially simultaneously.

50. Method according to claim 40, wherein said coupling occurs after said transferring.

51. Method according to claim 40, wherein said coupling is achieved by using pressure.

52. Method according to claim 40, wherein said coupling is achieved by using heat.

53. Apparatus for manufacturing a flexible interlayer for laminated glass, comprising a first feed device arranged for feeding a first layer arrangement towards a decorating zone, said decorating zone being provided with a transfer device that is so configured as to transfer a decorative pattern onto said first layer arrangement from a support element on which said decorative pattern is initially supported, downstream of said decorating zone a coupling device being provided arranged for coupling said first layer arrangement with a second layer arrangement so as to obtain said flexible interlayer, wherein the apparatus further comprises a winding arrangement, suitable for winding said flexible interlayer onto a reel.

54. Apparatus according to claim 53, wherein said transfer device comprises a pressure arrangement suitable for applying pressure to said support element when it is in contact with said first layer arrangement.

55. Apparatus according to claim 54, wherein said pressure arrangement comprises roller elements.

56. Apparatus according to claim 55, wherein said roller elements are clad with a material selected from a group consisting of: rubber, silicone.

57. Apparatus according to claim 55, wherein said roller elements are provided with an adjusting element arranged for adjusting the pressure exerted by said roller elements on said first layer arrangement and on said support element.

58. Apparatus according to claim 53, wherein said transfer device comprises a heating arrangement, suitable for heating said support element.

59. Apparatus according to claim 55, wherein said transfer device comprises a heating arrangement, suitable for heating said support element.

60. Apparatus according to claim 59, wherein said heating arrangement is associated with said roller elements.

61. Apparatus according to claim 53 wherein said transfer device comprises a further heating arrangement suitable for heating said first layer arrangement.

62. Apparatus according to claim 58, wherein said further heating arrangement is associated with said roller device.

63. Apparatus according to claim 53 wherein said first feed device comprises a first associating arrangement arranged for associating a first base layer of said first layer arrangement with a first protection layer of said first layer arrangement.

64. Apparatus according to claim 63, wherein said first associating arrangement comprises a pair of cylinders.

65. Apparatus according to claim 53, wherein said second feed device comprises a second associating arrangement arranged for associating a second base layer of said second layer arrangement with a second protection layer of said second layer arrangement.

66. Apparatus according to claim 65, wherein said second associating arrangement comprises a further pair of cylinders.

67. Apparatus according to claim 53, wherein said coupling device is so configured as to apply pressure to said first layer arrangement and to said second layer arrangement.

68. Apparatus according to claim 53, wherein said coupling device is so configured as to apply heat to said first layer arrangement and to said second layer arrangement.

69. Apparatus according to claim 53, wherein said coupling device comprises a further roller device.

70. Flexible decorating interlayer, comprising base layer arrangement bearing a decorative pattern, said base layer arrangement being associated with a protection arrangement that serves to prevent said base layer arrangement from sticking to adjacent materials, wherein said base layer arrangement is interposed between a first protection layer and a second protection layer of said protection arrangement.

71. Flexible decorating interlayer according to claim 70, wherein said base layer arrangement comprises a first base layer bearing said decorative pattern.

72. Flexible decorating interlayer according to claim 71, wherein said base layer arrangement comprises a second base layer arranged on a side of said decorative pattern opposite to said first base layer.

73. Flexible decorating interlayer according to claim 72, wherein said first protection layer is in contact with said first base layer and said second protection layer is in contact with said second base layer.

74. Flexible decorating interlayer according to claim 70, wherein said protection arrangement is made of a material with low adhesive power.

75. Flexible decorating interlayer according to claim 74, wherein said material with low adhesive power is selected from a group consisting of: polypropylene (PP), polyethylene (PE).

76. Flexible decorating interlayer, comprising base layer arrangement bearing a decorative pattern, said base layer arrangement being associated with a protection arrangement in contact with said decorative pattern for preventing said base layer arrangement from sticking to adjacent materials, wherein said protection arrangement comprises an exhaust support from which said decorative pattern has been released to be transferred onto said base layer arrangement.

77. Flexible decorating interlayer according to claim 76, wherein said protection layer is made of polypropylene (PP).

78. Flexible decorating interlayer according to claim 70, wherein said base layer arrangement is made of a material selected from a group consisting of: polyvinyl butyral (PVB), polyurethane (PU), ethylene vinyl acetate (EVA).

79. Flexible decorating interlayer according to claim 76, wherein said base layer arrangement is made of a material selected from a group consisting of: polyvinyl butyral (PVB), polyurethane (PU), ethylene vinyl acetate (EVA).

80. Flexible decorating interlayer according to claim 70, wherein said decorative pattern is printed with light-resistant inks.

81. Flexible decorating interlayer according to claim 76, wherein said decorative pattern is printed with light-resistant inks.
